(19) United States
(12) Patent Application Publication
(10) Pub. No.: US 2015/0095203 A1
(43) Pub. Date: Apr. 2, 2015

(54) METHOD AND SYSTEM FOR DETECTION OF ANOMALIES IN A MERCHANT CASH PAYMENT FLOW

(71) Applicant: MasterCard International Incorporated, Purchase, NY (US)

(72) Inventor: Justin Xavier Howe, Oakdale, NY (US)

(73) Assignee: MasterCard International Incorporated, Purchase, NY (US)

(21) Appl. No.: 14/039,178

(22) Filed: Sep. 27, 2013

(51) Int. Cl. G06Q 40/00

(52) U.S. Cl. CPC G06Q 40/12
USPC 705/30

(57) ABSTRACT

A method and system of detecting anomalies in cash flow to and from a merchant includes receiving records from sources of cash flow to and records of deposits of cash flow from the merchant. The records of cash flow to the merchant are preferably provided from external sources independent of the merchant operations. Each record includes a merchant identifier associated with the merchant and a total amount of cash. The records of cash flow to and from the merchant are compared for anomalies and the merchant is flagged for further financial review in response to detecting an anomaly between the records of cash flow to the merchant and the records of cash flow from the merchant. The anomaly can be a discrepancy between the independent records of cash flow to the merchant and a revenue reported by the merchant.

### FIELD OF THE DISCLOSURE

The present disclosure relates to monitoring cash payment flow within a retail environment and, more particularly, to a method and system for detection of the flow of cash to and from a merchant.

### BACKGROUND

The prevalence of cashless transactions using, for example, debit, credit, or other payment cards, or other electronic forms of payment, have produced a convenient method for merchants as well as consumers to track their revenues and expenditures. For most types of cashless sales transactions, an electronic record of the transaction is automatically generated at the time of the sale, so that daily records of such sales can be easily computed by the merchant.

Cashless sales transactions also ease the burden of a merchant in timely and correctly assessing taxable revenues. However, cash (i.e., currency) is still the main source of revenue for many merchants. Since there is no known method for the digitization of cash received by a merchant from all sources of revenue, it is difficult for the merchant entity to accurately and timely assess its cash revenue. The failure of a merchant to accurately track cash flow can result in losses due to theft and losses due to the inadvertent intake of counterfeit currency. In addition, the failure to accurately track all revenue leads to inaccurate reporting of cash revenues to taxing authorities. While the merchant can employ cash counting machines at cash registers and take other measures to internally track cash within the retail environment, such measures can be easily circumvented by employees, or even the merchants themselves, by skimming off the top without ever recording the sale.

There is a need, therefore, for a system and method of detecting anomalies in the flow of currency to and from a merchant, preferably using sources independent of the merchant's internal operations.

### SUMMARY

The present disclosure is directed to a method and system of detecting anomalies in a flow of cash to and from a merchant. In one aspect, the method includes receiving, using a processing device, records from sources of cash flow to a merchant and records of deposits of cash flow from the merchant, and comparing, using the processing device, the records from the sources of cash flow to the merchant with records of deposits of cash flow from the merchant. Each of the records includes a merchant identifier associated with the merchant and a total amount of cash associated with the cash flow. The method further includes flagging, using the processing device, the merchant for further financial review in response to detecting an anomaly between the records of cash flow to the merchant and the records of cash flow from the merchant.

Each of the records can further include a denomination associated with each piece of currency forming the total amount of cash.

In an additional aspect, the anomaly detected can be that a percentage of the currency in the cash flow from the merchant having the denomination of twenty dollars or more is less than a percentage of the currency in the cash flow to the merchant having the denomination of twenty dollars or more.

In various aspects, the sources of cash flow can include consumer-operated devices, the records of sources of cash flow to the merchant including a record of cash receipt submitted by a consumer as proof of cash payment to the merchant for goods or services.

In an additional aspect, the record of cash receipt can include an image of at least one of the cash receipt and of each of the piece of currency forming the total amount of cash paid by the consumer.

In yet another aspect, the record of cash receipt is provided by an application on the consumer-operated device and the merchant identifier is a location generated by the application.

In still another aspect, the method further includes aggregating the records from the sources of cash flow to the merchant over a predetermined period of time, and estimating a total cash revenue associated with the merchant from the aggregated records over the predetermined period of time.

In one aspect, the estimated total cash revenue can be a reported revenue associated with the merchant, the anomaly corresponding to the estimated total cash flow exceeding the reported revenue.

The records of the deposits of cash flow from the merchant can include records from a cash-in-transit operator and/or a financial institution.

In various additional aspects, each of the records of cash flow to the merchant and from the merchant can further include serial numbers corresponding to each of the piece of currency.

In one aspect, the method can further include identifying the serial numbers and associated denomination of each piece of currency in the records of cash flow to the merchant that are unaccounted for in the records of the deposits.

In another aspect, the sources of cash flow to the merchant include possible sources of cash to a consumer. The possible sources are identified by a predetermined geographic proximity to the merchant, and include automatic teller machines.

Additional records can be received that are associated with cash flow to and from additional merchants within the predetermined geographic proximity to the merchant. The anomaly can then be detected based on comparing the cash flow to and from the merchant with the cash flow to and from the additional merchants.

The disclosure is also directed to an apparatus to detect anomalies in a flow of cash to and from a merchant. In one aspect, the apparatus includes a processing device; and memory to store instructions that, when executed by the processing device, cause the processing device to perform operations including receiving records from sources of cash flow to a merchant and records of deposits of cash flow from the merchant; comparing the records from the sources of cash flow to the merchant with records of deposits of cash flow from the merchant; and flagging the merchant for further financial review in response to detecting from the comparing step an anomaly between the records of cash flow to the merchant and the records of cash flow from the merchant.

Each of the records includes a merchant identifier associated with the merchant and a total amount of cash associated with the cash flow.

In one aspect, each of the records further includes a denomination associated with each piece of currency forming the total amount of cash.

In another aspect, the anomaly detected is that a percentage of the currency in the cash flow from the merchant having the denomination of twenty dollars or more is less than a percentage of the currency in the cash flow to the merchant having the denomination of twenty dollars or more.

The sources of cash flow can include consumer-operated devices, the records of sources of cash flow to the merchant including a record of cash receipt submitted by a consumer as proof of cash payment to the merchant for goods or services.

In one aspect, the record of cash receipt includes an image of at least one of the cash receipt and of each of the piece of currency forming the total amount of cash paid by the consumer.

The record of cash receipt can be provided by an application on the consumer-operated device and the merchant identifier is a location generated by the application.

In another aspect, the sources of cash flow to the merchant include possible sources of cash to a consumer. The possible sources are identified by a predetermined geographic proximity to the merchant, and preferably include automatic teller machines. The operations further include receiving additional records associated with cash flow to and from additional merchants within the predetermined geographic proximity to the merchant, the anomaly being further based on comparing the cash flow to and from the merchant with the cash flow to and from the additional merchants.

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

FIG. 1 is a schematic representation of an embodiment of a system for implementing various embodiments of the methods of the present disclosure.

FIG. 2 is a schematic representation of a flow of cash within a retail environment.

FIG. 3 is a flow diagram representation of an embodiment of a method for detecting anomalies in a merchant's cash flow in accordance with the present disclosure.

FIG. 4 is a schematic representation of channels of cash flow to and from a merchant in the retail environment.

FIG. 5A is a flow diagram representation of another embodiment of a method for detecting anomalies in a merchant's cash flow in accordance with the present disclosure.

FIG. 5B is a flow diagram representation of yet another embodiment of a method for detecting anomalies in a merchant's cash flow in accordance with the present disclosure.

### DETAILED DESCRIPTION OF THE EMBODIMENTS

The following sections describe particular embodiments. It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present method and system as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

It should also be understood that the order of steps or order for performing certain actions is immaterial, as long as the method remains operable. Moreover, two or more steps or actions may be conducted simultaneously.

A “cash-in-transit” (“CIT”) operator refers to any cash courier, including armored car services.

The term “cash flow” describes bill and coin delivery, pickups, deposits, and/or disbursements to/from(by) a financial institution and/or a CIT operator.

The term “currency” includes both paper and metal currency (coinage). Further, denomination refers to the amount (in dollars or cents for U.S. currency) appearing on and ascribed to a corresponding piece of currency (bill or coin).

“Serial number recognition” refers to the identification and capture, and recognition, for example, by optical character recognition, of a serial number on a piece of currency. Serial number recognition devices are commonly used to identify counterfeit currency. Devices known in the art as cash counters, currency discriminators, and/or currency validators often include serial number recognition in addition to the ability to discriminate denominations on currency and to count currency.

Types of cashless payments are well-known in the art and include, without limitation, any check, payment card, including credit and debit cards, or electronic payment made, for example, by contactless RFID-enabled devices including smart cards, NFC-enabled smartphones, and electronic mobile or on-line wallets.

The present disclosure is directed to a system and methods for detecting anomalies in cash flow to and from a merchant. If such anomalies are detected, the merchant's revenues can be flagged for further review. The method and system provide for the digitization and tracking of cash flow to and from merchants using sources external to and independent of the merchant's operations. In this way, true revenues can be estimated for a merchant for internal audits, as well as for external audits by, for example, taxing authorities.

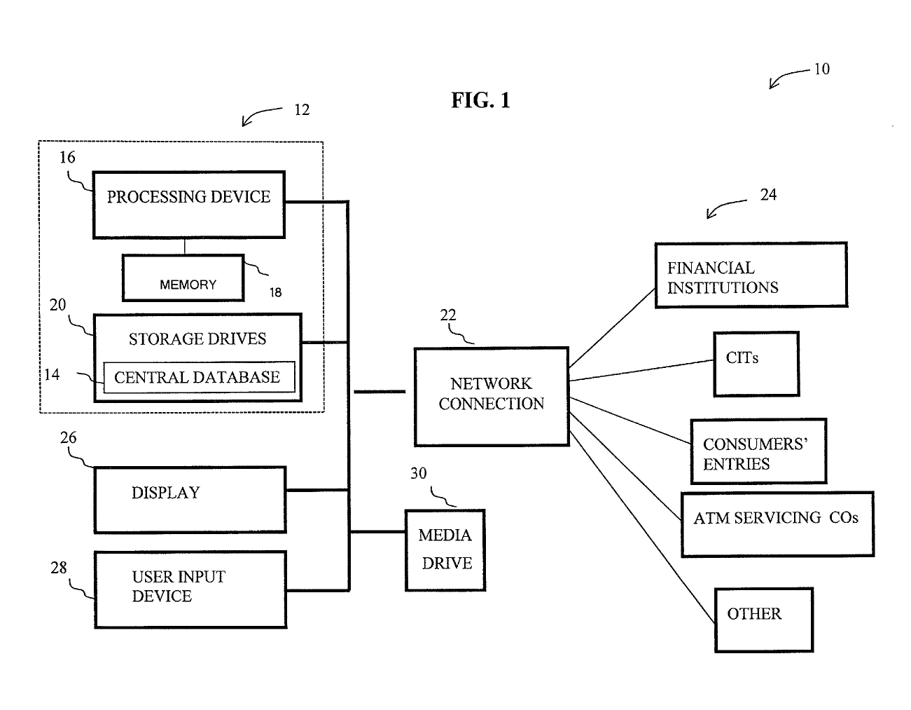

Referring to FIG. 1, the methods of the present disclosure are preferably enabled through a system 10 which includes a server 12, and a service, including computer programming application(s) or software, hosted on the server 12, and a central database 14 associated with the server 12 for storing records and data associated with the cash flow to and from each merchant. The service can be a web-hosted service accessed by consumers, for example, via a link to the service. As is well-known to those of ordinary skill in the art, an application can also be provided on customers' smart phones or other mobile devices for accessing the service and communicating records of cash transactions and other information to the server.

Referring still to FIG. 1, the various embodiments of the methods of the present disclosure are implemented via computer software or executable instructions or code. FIG. 1 is a schematic representation of one embodiment of a system 10 for implementing the methods of the present disclosure. The server 12 includes at least a processing device 16 including a Central Processing Unit (CPU), memory 18, storage drives 20, and interface hardware (Network Connection) 22 for connecting to external systems 24, via the Internet, for example, and to retrieve or receive records of cash flow associated with merchants. The external systems 24 include those associated with various financial institutions (referred to also herein as “banks”), cash-in-transit (CIT) operators, ATM servicing companies, and other intermediaries and entities associated with cash flow to and from merchants, including sources of records of cash transactions with merchants. For example, such external sources include smart phones on which applications are loaded for consumers to voluntarily capture and submit details of cash receipts and transactions with merchants as well as other mobile devices and computers from which consumers can log in to the service and upload the cash receipts and transactions. The transmitted, or optionally, retrieved, records from all sources of cash flow to and from merchants are preferably stored in the central database 14 for processing in accordance with the methods of the present disclosure.

As is known to those of skill in the art, a complete listing of all merchants corresponding to any geographical region can also be retrieved from a number of sources, for example, state taxing authorities. Preferably, such listings are also maintained in the central database 14 and include at least a merchant identifier and location, and industry classification. Additional information is also preferably retrieved to group the various merchants according to size, type, and geographic location and population density, to identify expected patterns of cash flow for different merchants as described herein.

In view of the current prevalence of cashless transactions, especially electronic and payment card transactions, it is feasible for many merchants to no longer accept cash for goods and services. Accordingly, merchants who declare to taxing authorities that they only accept electronically-recorded cashless transactions could be deemed exempt from any audits by taxing authorities. Such a program would reduce the number of merchants that need to be tracked by the methods of the present disclosure. Accordingly, in certain embodiments, the listings of merchants maintained in the central database 14 can be modified to remove merchants who report they are only dealing in cashless transactions.

Referring still to FIG. 1, the server 12 can be integrated with a computer workstation with display 26 and input keypad or keyboard 28. The memory 18 includes computer readable memory accessible by the CPU for storing the computer programs and instructions that when executed by the CPU 16 cause the processing device 16 to implement the steps of the methods described herein. The memory 18 can include random access memory (RAM), read only memory (ROM), a storage device including a hard drive, a portable, removable computer readable medium, such as a compact disk (CD) or a flash memory, or a combination thereof. The computer executable instructions for implementing the methods of the present disclosure may be stored in any one type of memory associated with the system 10, or distributed among various types of memory devices provided, and the necessary portions loaded into RAM, for example, upon execution.

In one embodiment, a non-transitory computer readable product is provided, which includes a computer readable medium that can be accessed by the CPU, via a media drive 30, for example, the computer readable medium storing computer executable instructions or program code for performing the method steps described herein.

It should be recognized that the components illustrated in FIG. 1 are exemplary only, and that it is contemplated that the methods described herein may be implemented by various combinations of hardware, software, firmware, circuitry, and/or processing devices and associated memory, for example, as well as other components known to those of ordinary skill in the art.

By way of background, during the normal course of business, most merchants receive cash from their customers in addition to receiving payment via other instruments. Such other instruments of payment include, for example, checks, debit cards, charge cards, electronic wallets, ATM cards, CHIP cards, PIN transactions, transponder devices, and NFC-enabled smart phones. All of these instruments of payment, with the exception of cash, are processed so that a record of the transaction is generated and transmitted at least to the financial institution authorizing payment. In turn, the financial institutions and other merchant services are currently required to report annual gross payments processed by checks and payment cards, such as credit or debit cards, to the IRS and to merchants using a Form 1099.

While there is no universal means of similarly tracking cash, there are currently available a variety of electronic cash-counting processes associated with a merchant's business that could be, and often are, voluntarily utilized by the merchant to estimate the flow of cash for the merchant's internal accounting and tax reporting purposes.

For example, cash counting machines that include serial number recognition as a way of identifying fraudulent currency are widely available. Many merchants have such machines in place and routinely run every piece of currency through the machines as a precautionary measure for fraud detection. Such machines may also be used for counting currency in every cash transaction, keeping running totals of cash as well as totals by denomination maintained in a register, and for tallying an expected total in a cash register upon cash-out, for example, at the end of the day.

Similarly, provisional credit safes, or smart safes are now commonly used by many merchants as a way of reducing the number of trips the merchant has to make to the bank to make physical deposits. A smart safe combines a currency validator, for both currency counting and counterfeit detection, with the ability to communicate electronically with the merchant's bank, typically via servers owned by a cash-in-transit (CIT) or armored car company (such as Brinks®). The currency validator keeps track of the amount of money deposited into the safe and communicates that information to the bank, the merchant and the CIT operator. The bank can then make funds provisionally available to the merchant even before the CIT physically deposits the funds to the bank on behalf of the merchant.

These tools are extremely useful and could be used by the merchant to create a digitally auditable trail of cash received at the register as well as of cash exiting the merchant through a CIT carrier. However, such a system is not useful for either the merchant's internal auditing purposes or tax reporting if an employee or owner circumvents the system by “skimming off the top” and receiving cash from customers without using the cash-counting register.

The method and system of the present disclosure provide an independent check on the accuracy of a merchant's accounting of cash revenue, by tracking the flow of cash to and from the merchant using information secured from sources external to the merchant's operation.

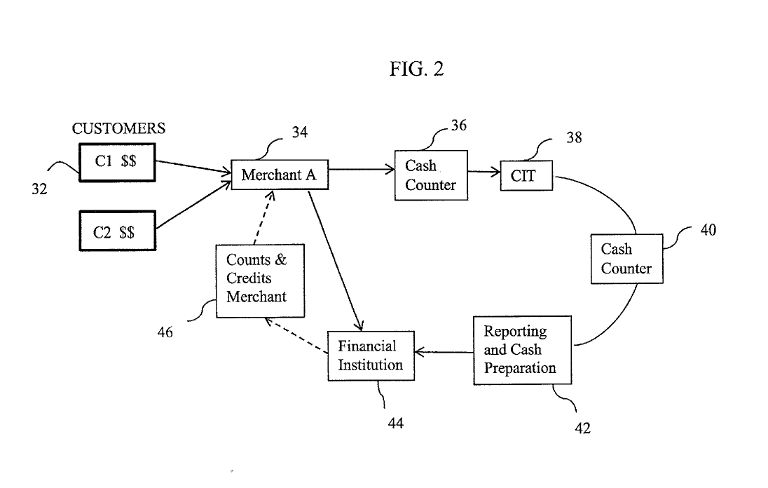

Referring to FIG. 2, a cash payment flow within a retail environment begins with a customer 32 paying a merchant 34 in cash for goods or services rendered. At the end of each day, or, in some cases, at the end of cashiers' shifts, the cash from the cash registers may be counted manually or by a cash counter 36 and then reconciled along with the additional modes of payment made for purchase during that time. Once counted and reconciled, the cash can be maintained in a local safe until it can be transported by a cash-in-transit (CIT) operator 38, such as an armored car. For example, the CIT operator may have scheduled pickups once a week. The operator of the CIT 38 counts the cash upon pickup, preferably using a cash counter 40 that also has serial number recognition for counterfeit detection, and preferably prepares reports 42 for both the financial institution (e.g., bank) and the merchant verifying the amount of cash picked up for delivery. The cash is then delivered to the financial institution (also referred to herein as a bank) 44, which, in turn credits the merchant's account 46, preferably after verifying the amount of cash reported by the CIT for delivery. The merchant may also, on occasion, deliver cash directly to the bank 44.

Of course, for many smaller retail operations, the expense of a CIT is considered unwarranted and the merchant will only deliver cash directly to the bank 44 on a periodic basis. In the latter case, the only external record of the merchant's cash revenue is the bank's record of cash deposited into the merchant's account.

Although it is understood that a certain amount of reserve will be retained by the merchant in order to have change in the cash registers, for example, the amount of reserve should be somewhat constant. The regular CIT reports to the bank and merchant, therefore, as well as records of a merchant's deposits to the bank account associated with the merchant, could provide a good estimate of cash revenue over the time period between pick-ups for certain merchants. The currency counters used by CITs and banks also use serial number recognition for counterfeit detection. Accordingly, the ability to record the serial numbers along with the particular denominations of currency collected also already exists. In addition, the records generated preferably have an account number or other merchant identifier and/or merchant location associated with them.

In various embodiments of the present disclosure, the cash input from the various sources of cash flow to the merchant are aggregated over a predetermined period of time and compared to cash revenue recorded by the merchant. As well-known to those in the art, the cash revenue of the merchant can be calculated as the Reported Revenue (for example, to the IRS) minus all card and check payments. If an anomaly is detected in the recorded (or reported) revenue, based on the flow of cash tracked by the service, then further financial review of the merchant's reported revenue is warranted.

For example, an anomaly exists if the aggregated cash flow to the merchant is greater than the reported cash revenue, or, optionally, greater by a predetermined amount. In some cases, a certain amount of overage in the amount of cash flow in versus that reported could be part of the normal course of business (i.e., related to drawdown of operating cash or caused by seasonal fluctuations), or part of the cash flow to the merchant could be carried over to a later reporting period.

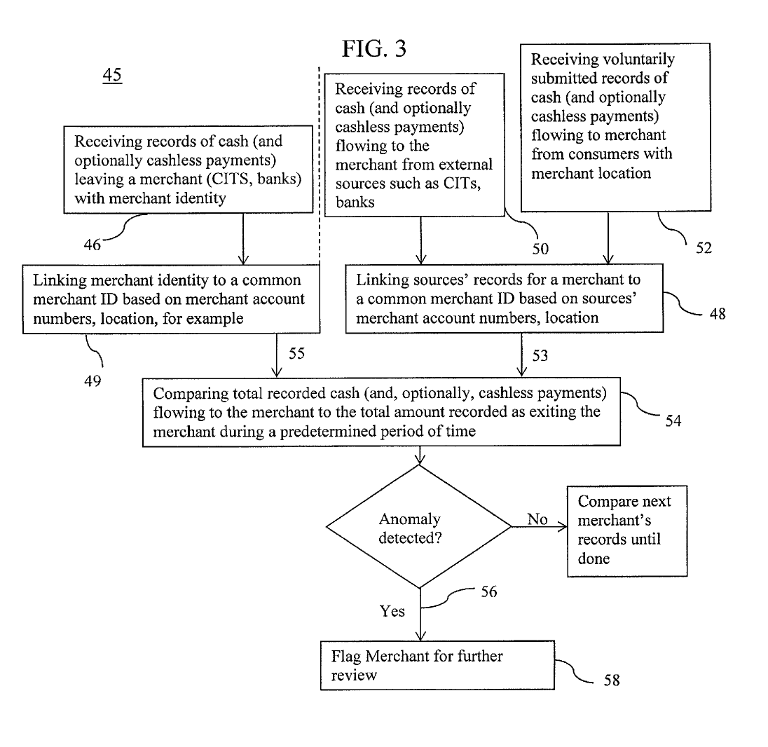

Referring to FIG. 3, in one embodiment of a method 45 of the present disclosure, records of the amount of cash exiting a merchant during a predetermined period of time are generated and transmitted and received 46 by the server. Preferably, the exact breakdown of the denominations of currency (how many of each denomination) is transmitted along with the associated merchant identifier and/or location to the server. In various embodiments, the serial numbers of the currency are also recorded and transmitted. The records of the cash exiting a merchant include those records generated by the CITs on pick-up and those directly deposited to the bank by the merchant, for example. Such detailed records from both the banks and the CITs should already be routinely available from the cash counters and validators used by CITs and banks.

To implement the methods of the present disclosure, the account numbers used by the CITs, banks, and other sources of recorded cash transaction data for a particular merchant must be linked. One embodiment of the present disclosure includes linking the CITs, banks', and other sources' records for a particular merchant to a common merchant identifier 48, for example, using the reported merchant location. In some instances, such as customer generated receipts at point of sale, for example, via an application on a mobile device, a location can be automatically transmitted with the details of the cash transaction. Preferably, the common merchant identifier is also linked to a merchant identity associated with records of cash leaving a merchant 49, as provided by CITs and banks, for example.

In reference to a merchant identifier as used herein, it is understood that the merchant identifier is a common merchant identifier, or can be linked to a common merchant identifier from a merchant location, account number, tax ID, or other identifier of a merchant transmitted with the records of each source of cash flow associated with a merchant.

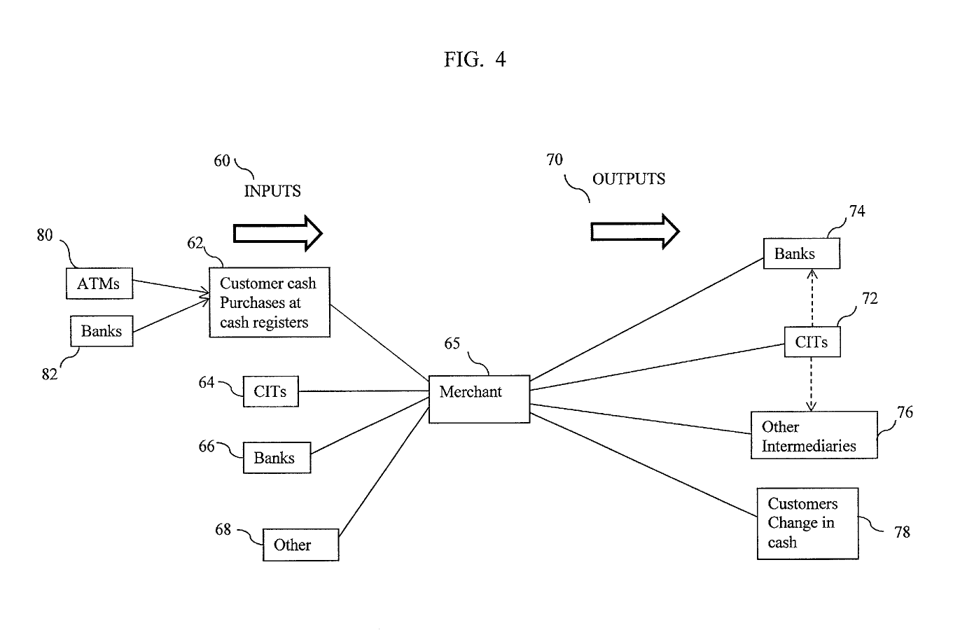

Still referring to FIG. 3, the method also includes receiving records of cash currency flowing to the merchant from external sources 50. Referring also to FIG. 4, such external sources can include deliveries from CITs 64 and withdrawals from a merchant's bank accounts 66. Detailed records are generated for sources of cash from the CITs and the banks with details of currency denominations and, optionally, serial numbers, as described above, and transmitted along with the merchant identifier and/or location, to the service. However, the largest influx of currency may come from the customers, despite the current prevalence of non-cash transactions.

Referring again to FIG. 3, preferably, the method also includes recording voluntary submissions of cash receipts from customers 52 of the merchant as another external source of information about the merchant's cash revenues. Preferably, the exact breakdown of the denominations of currency (how many of each denomination) used by the consumer to make the purchase are transmitted along with the associated merchant identifier and/or location to the server. In various embodiments, the serial numbers of the currency are also recorded and transmitted. The total amount of reported cash flowing to the merchant 53, including from customers' voluntary submissions, to the total amount recorded as exiting the merchant 55 during a predetermined period of time is then compared 54. If an anomaly in the cash flow to the merchant based on the recorded cash leaving the merchant is detected 56, the merchant is flagged for further financial review of reported cash revenue 58. This process can be completed for each merchant listed in the central database.

As an example of an anomaly that would trigger further review, if the total amount of cash reported by consumers and other sources as flowing to the merchant during a predetermined period of time exceeds the amount recorded, for example, by the CIT and bank deposit records, for that same time period, the merchant may be losing cash revenue due to employee theft, or the merchant may be engaging in tax evasion. In another example, if the amount of cash flowing to the merchant as reported from consumers' receipts and other sources during a calendar year exceeds the amount of cash revenues reported by the merchant to a taxing authority for that calendar year, further financial review by the taxing authority would be warranted of the accuracy of the merchant's reported revenues.

Accordingly, the collective voluntary submission of cash receipts from consumers can be a useful and independent tool for verifying a merchant's cash revenue. To facilitate consumers' participation, in various embodiments of the disclosure, the method includes consumers' uploading images of receipts from merchants and/or submitting information from the receipts for cash transactions via the link to the web-hosted service or via an application installed on the consumer's smart phone or other mobile device. In addition, images of the actual currency to show both the amount and serial numbers on the currency can preferably also be uploaded to the server. Various tools are known in the art and can be employed to extract the necessary information from the receipts as well as from images of the currency a consumer uses for the purchase.

For example, existing receipt tracking tools, such as Shoeboxed.com and Lemon.com, can be integrated with the methods of the present disclosure. Such receipt tracking tools allow consumers to record an amount and purpose (goods or services purchased) of receipts from merchants for cash purchases.

In further embodiments, an application is provided for both capturing the details of the receipt and for imaging the cash used for the purchase, including capturing the serial number and denominations of the bills. The images can be uploaded via the application to the server. Optionally, subsequent data extraction techniques can be applied, for example, optical character recognition (OCR), to record and transmit the details from both the receipt and each bill (such as the denomination and serial number). Similarly, existing applications for digitization of checks can be adapted for imaging and transmitting details of both receipts and currency used for the purchase.

Preferably, the application also tracks and transmits the location of the merchant with the record of the cash transaction. In certain embodiments, the consumer also or, alternatively, manually enters the merchant name and/or address.

Of course, the success of implementing a method that relies entirely on voluntary participation requires that a large percentage of consumers who frequent the merchant in question participate. It is, therefore, advantageous to gather additional information on incoming cash revenues from sources requiring participation from neither the merchant nor the consumer, but instead, preferably, from commercially available databases.

In reference to FIG. 3 and to other embodiments described herein, it is understood that records of cashless transactions received by and flowing from the merchant can also be received and compared, along with the records of cash flow, for assessing any anomalies in a merchant's reported revenues in accordance with the present disclosure.

Referring to FIG. 4, sources of cash 60 entering a merchant establishment can include cash tendered by the customer for goods and services 62; CIT (armored car) deliveries 64; merchant pick-ups from a bank (or bank deliveries) 66 as well as other sources 68.

Cash can flow from the merchants 65 via a CIT 72, presumably into the merchant's account at a bank 74. However, the CIT 72 could also pick up cash for delivery elsewhere, for example, to an intermediary 76, such as another business location (perhaps in the case of a franchise), or to a co-owned retail location. Of course, cash could also flow to the bank 74 and/or to the intermediary 76 without the use of the CIT 72 and without any electronic record of the cash. Cash can also flow from the merchant back to customers 78 in the way of change.

Preferably, records associated with each of the cash inputs to a merchant are regularly transmitted to the server. The records include at least a merchant identifier and/or location, a total amount of cash, and a date and time associated with each record. For example, the records preferably include records of withdrawals and/or deposits to the bank 66, and/or cash deliveries by the CIT 64 of cash to the merchant. In each case, records are generated with timestamps and merchant identifiers, locations, or other identifiers that can be linked to the merchant. It is noted that the CITs 64 and banks 66 indicated as sources of records for cash flow to the merchant in FIG. 4 may, of course, be the same entities as CITs 72 and banks 74 the merchant uses to deposit cash, and which can provide corresponding records of cash flow from the merchant.

Records of consumer purchases are preferably provided voluntarily by consumers, as described supra, by submitting details of cash transactions via an application or by uploading the details directly to the server. The consumer-submitted records preferably include a merchant identifier and/or a location of the purchase in addition to the details of the cash tendered, i.e., the denominations of currency used for the purchase, and purchase details.

In various additional embodiments, the records transmitted to the server also include the serial numbers associated with each. For example, the serial numbers can be recorded at the time the cash counter and validators are used by the financial institutions and CITs. In the case of voluntary consumer submissions, the serial numbers can be imaged along with the denomination for uploading to the service.

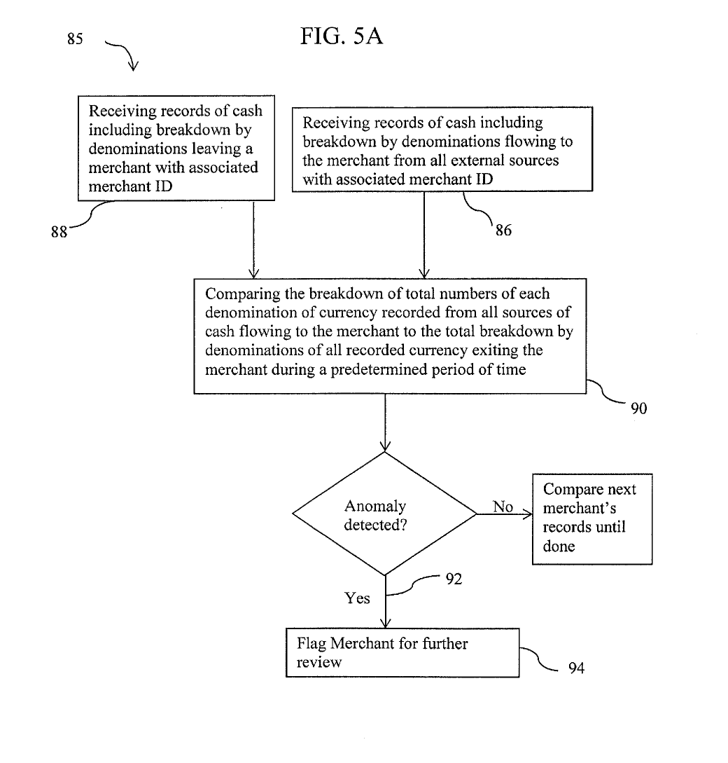

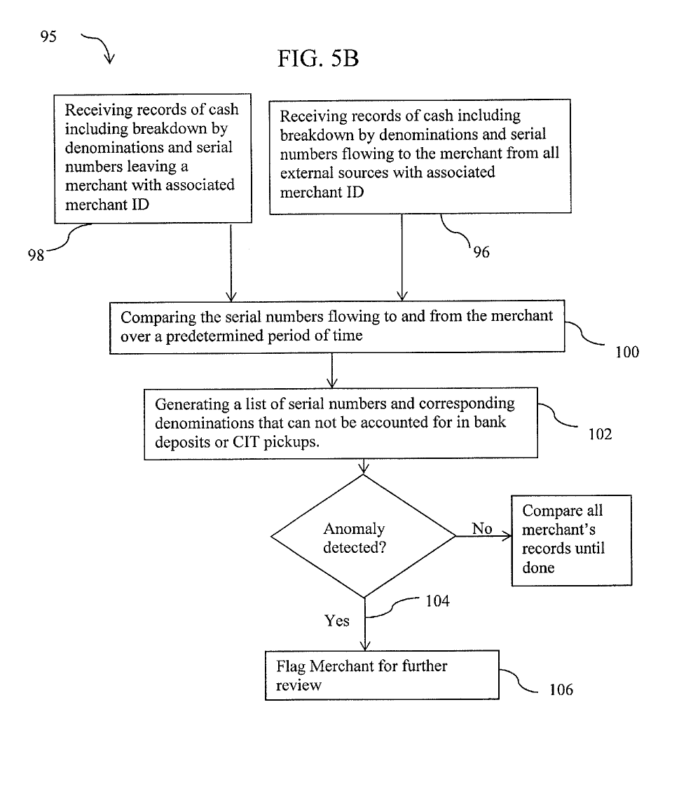

Referring to FIG. 5A, in one embodiment 85, after recording the breakdown by denomination (the number of bills of each denomination along with the total amount of cash) of the currency flowing into a merchant 86 and from the merchant 88, via CIT's, banks, consumers, and so on, the breakdown of the denominations of currency to and from the merchant are compared 90. Further review of the merchant's reported cash revenues is flagged 94 in response to certain detected discrepancies or anomalies 92 between the breakdown by denomination flowing to the merchant versus the breakdown by currency of what is deposited in the bank.

For example, most merchants habitually need smaller denominations to make change. Accordingly, the smaller denominations flowing to the merchant would be expected to be retained and the larger denominations flowing in would be expected to be deposited in the bank. In various embodiments, if the number of bills of predetermined larger denominations (for example, $20 or more, $50 or more, or $100 or more, depending on the nature of the business) flowing into the merchant exceeds the number of bills of one or more of those predetermined larger denominations being deposited in the bank, the merchant is flagged for further review of the accuracy of its recorded cash revenue and internal cash flow.

Referring to FIG. 5B, in another embodiment 95, the flow of cash is tracked by the serial numbers and associated denominations of currency flowing into a merchant 96, via CIT's, banks, consumers, and so on, and by the serial numbers of currency by denomination that leave the merchant 98. The serial numbers of cash leaving the merchant over a period of time are then compared to the serial numbers of cash that flowed in 100, and a list of serial numbers and corresponding denominations that cannot be accounted for by bank deposits or CIT pickups is generated 102.

Further review of the merchant's reported cash revenues is flagged 106 based on certain detected discrepancies between the flow of serial numbers in each denomination to the bank post payments as determined by the list generated 104. For example, if the missing serial numbers represent a disproportionate number of predetermined larger denominations of bills (for example, $20 or more, $50 or more, or $100 or more, depending on the nature of the business) not being deposited, the merchant is flagged for further review of its reported cash revenue.

In addition, money laundering investigations would particularly benefit from such tracking of serial number data.

In particular embodiments of the present disclosure, in addition to obtaining records of receipts volunteered by consumers, records of cash flow can be tracked around the location of the merchant. In particular, referring to FIG. 4, many consumers will retrieve cash from an automatic teller machine (ATM) 80 that is near the merchant from which goods or services are purchased with cash. ATM stocking services presumably run cash through a cash counter before dispensing the cash (in the form of twenty-dollar bills) in the ATM machine. In accordance with various methods of the present disclosure, the serial numbers are also captured and recorded with the records of cash deposited in each ATM and are transmitted, along with a location of the ATM machine, to the server.

In one embodiment, the serial numbers and denominations of currency delivered to consumers via ATMs and, optionally, in bank withdrawals in a particular geographical area surrounding a number of merchants are recorded, as well as the serial numbers of all currency delivered directly to those merchants via the other sources of recorded inputs 60. In addition, the serial number and amounts of all recorded currency leaving those merchants 70 and deposited in a bank are recorded within a predetermined period of time. Using methods known in the art, such as flow network (also known as transportation network) graphs and analysis, anomalies in the flow of cash to and from merchants can be identified. Presumably, in a normal flow, banks, and ATMs, in particular, will be identified as sources of cash in the network. An even distribution of flow in and out of each of the merchants and back to the banks would be expected. An anomaly of cash flowing to a merchant can be identified, for example, where the amount of flow to the merchant in comparison to the amount flowing out, and in comparison to similar types of merchant, is abnormally high.

In similar embodiments, even without the additional record and tracking of serial numbers, patterns in the amounts of particular types of denominations can be tracked. For example, referring to FIG. 4 and FIG. 5A, cash flowing to a merchant 65 as deliveries by armored car 64 or picked up from a bank 66 would typically comprise lower value denominations and coins to be used for change, while currency from customers 62, which is not returned as change to some other customer during the course of a day, will tend to constitute larger denominations. Accordingly, outputs 70 from most merchants to banks would be expected to include mostly larger denominations, the smaller denominations being reserved for use as change.

Another anomaly in cash flow is detected 92, therefore, if the recorded amounts of denominations deposited directly by a particular merchant and/or by the CIT 72 to the bank 74 comprise an abnormally low percentage of larger denominations being deposited in comparison to the deposits recorded for similar types of merchants.

As another example, merchants that are located within a particular predetermined region, or within a particular radius, for example, of an ATM, would be expected to see a large number of twenty-dollar bills used as cash. Accordingly, if a majority of merchants within the same area have a recorded output 70 comprising a large percentage of twenty-dollar bills in comparison to other denominations, the anomalous merchant that does not show the same pattern of cash deposits is preferably flagged 94 for further review of its reported revenue.

Generally, by looking at the total population of cash transactions through a geographical cluster of merchants, abnormalities can be identified and those merchants flagged for a detailed review of their revenues and internal cash flow.

By tracking the flow of various denominations of currency to and from a number of different, reliable, merchants over time, expected patterns can be defined for different types of merchants in different geographical locations and settings (rural, urban, suburban) to facilitate the identification of other anomalies in the normal flow of cash to and from a retail environment.

Various methods can be used to store the denomination of currency for tracking in accordance with the various embodiments of the present disclosure. For example, the denominations, in addition to checks and payment card receipts, in each deposit/delivery/pick-up can be stored in a database as a multi-dimension variable, with an additional reference to a unique Merchant ID.

For example, the data structure {P, N, D, Q, S, 1, 2, 5, 10, 20, 50, 100} can be used to denote the fields for the numbers of currency with denominations for {penny, nickel, dime, quarter, silver dollar, dollar, two-dollar, five-dollar, ten-dollar, twenty-dollar, fifty dollar, and a hundred dollar bill}. As an example, the following stored values represent $25,703.00 as the total cash deposit amount: {100, 100, 100, 40, 1, 120, 3, 200, 400, 1000, 3, 4}.

One of ordinary skill in the art will recognize that if plotted in a multidimensional space, deposits with identical ratio of each denomination to the other would fall on the same ray in multidimensional space. Accordingly, deposits featuring unusual ratios of currency would fall in atypical regions of the multidimensional space and could accordingly be identified. Similar methods could be applied to the summation of deposits/deliveries/pick-ups to identify merchant locations with unusual cash flow relative to their industry.

In additional embodiments, all deposit, location, and cash/check/card comparisons can be conducted using well-known multivariate methods, including clustering, hierarchical agglomeration, and so on that are known in the art.

While the methods and system of the present disclosure have been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present methods and system as defined by the accompanying claims and equivalents thereto.

What is claimed is:

1. A method of detecting anomalies in cash flow to and from a merchant, the method comprising:
receiving, using a processing device, records from sources of cash flow to a merchant and records of deposits of cash flow from the merchant, each of the records comprising a merchant identifier associated with the merchant and a total amount of cash associated with the cash flow;
comparing, using the processing device, the records from the sources of cash flow to the merchant with records of deposits of cash flow from the merchant; and
flagging, using the processing device, the merchant for further financial review in response to detecting, using the processing device, from the comparing step an anomaly between the records of cash flow to the merchant and the records of cash flow from the merchant.

2. The method of claim 1, wherein each of the records further comprises a denomination associated with each piece of currency forming the total amount of cash.

3. The method of claim 2, wherein the anomaly comprises a percentage of the currency in the cash flow from the merchant having the denomination of twenty dollars or more being less than a percentage of the currency in the cash flow to the merchant having the denomination of twenty dollars or more.

4. The method of claim 1, wherein the sources of cash flow include consumer-operated devices, the records of sources of cash flow to the merchant including a record of cash receipt submitted by a consumer as proof of cash payment to the merchant for goods or services.

5. The method of claim 4, wherein the record of cash receipt includes an image of at least one of the cash receipt and of each of the piece of currency forming the total amount of cash paid by the consumer.

6. The method of claim 5, wherein the record of cash receipt is provided by an application on the consumer-operated device and the merchant identifier is a location generated by the application.

7. The method of claim 4, further comprising aggregating the records from the sources of cash flow to the merchant over a predetermined period of time, and estimating a total cash revenue associated with the merchant from the aggregated records over the predetermined period of time.

8. The method of claim 7, wherein the comparing further comprises comparing the estimated total cash revenue to a reported revenue associated with the merchant, and wherein the anomaly corresponds to the estimated total cash flow exceeding the reported revenue.

9. The method of claim 1, wherein the records of the deposits of cash flow from the merchant include records from at least one of a cash-in-transit operator and a financial institution.

10. The method of claim 2, wherein each of the records of cash flow to the merchant and from the merchant further comprises serial numbers corresponding to each of the piece of currency.

11. The method of claim 10, further comprising identifying the serial numbers and associated denomination of each of the piece of currency in the records of cash flow to the merchant that is unaccounted for in the records of the deposits.

12. The method of claim 1, wherein the sources of cash flow to the merchant include possible sources of cash to a consumer, wherein the possible sources are identified by a predetermined geographic proximity to the merchant, the possible sources including automatic teller machines.

13. The method of claim 12, further comprising receiving additional records associated with cash flow to and from additional merchants within the predetermined geographic proximity to the merchant, and wherein the anomaly is further based on comparing the cash flow to and from the merchant with the cash flow to and from the additional merchants.

14. An apparatus to detect anomalies in cash flow to and from a merchant, the apparatus comprising:
a processing device; and
memory to store instructions that, when executed by the processing device, cause the processing device to perform operations comprising:
receiving records from sources of cash flow to a merchant and records of deposits of cash flow from the merchant, each of the records comprising a merchant identifier associated with the merchant and a total amount of cash associated with the cash flow;
comparing the records from the sources of cash flow to the merchant with records of deposits of cash flow from the merchant; and
flagging the merchant for further financial review in response to detecting from the comparing step an anomaly between the records of cash flow to the merchant and the records of cash flow from the merchant.

15. The apparatus of claim 14, wherein each of the records further comprises a denomination associated with each piece of currency forming the total amount of cash.

16. The apparatus of claim 15, wherein the anomaly comprises a percentage of the currency in the cash flow from the merchant having the denomination of twenty dollars or more being less than a percentage of the currency in the cash flow to the merchant having the denomination of twenty dollars or more.

17. The apparatus of claim 14, wherein the sources of cash flow include consumer-operated devices, the records of sources of cash flow to the merchant including a record of cash receipt submitted by a consumer as proof of cash payment to the merchant for goods or services.

18. The apparatus of claim 17, wherein the record of cash receipt includes an image of at least one of the cash receipt and of each of the piece of currency forming the total amount of cash paid by the consumer.

19. The apparatus of claim 17, wherein the record of cash receipt is provided by an application on the consumer-operated device and the merchant identifier is a location generated by the application.

20. The apparatus of claim 14, wherein the sources of cash flow to the merchant include possible sources of cash to a consumer, wherein the possible sources are identified by a predetermined geographic proximity to the merchant, the possible sources including automatic teller machines, the operations further comprising receiving additional records associated with cash flow to and from additional merchants within the predetermined geographic proximity to the merchant, and wherein the anomaly is further based on comparing the cash flow to and from the merchant with the cash flow to and from the additional merchants.
